(19) United States
(12) Patent Application Publication
(10) Pub. No.: US 2015/0028114 A1
(43) Pub. Date: Jan. 29, 2015

(54) APPARATUS AND METHOD FOR CONTROLLING A HEATING VENTILATION AND / OR AIR CONDITIONING SYSTEM UTILIZING AN INFRARED SENSING OR IMAGING DEVICE FOR DETERMINING RADIATED TEMPERATURE OF ONE OR MORE OBJECTS OR OCCUPANTS IN THE CONDITIONED SPACE

(71) Applicant: Howard Rosen, Quebec (CA)

(72) Inventor: Howard Rosen, Quebec (CA)

(21) Appl. No.: 13/953,135

(22) Filed: Jul. 29, 2013

(51) Int. Cl. G05D 23/19

(52) U.S. Cl. CPC G05D 23/19
USPC 236/51

(57) ABSTRACT

A method and/or thermostat apparatus incorporating an infrared sensor or infrared imaging device and utilizing one or more images or measurements of infrared energy from the infrared sensor or imaging device in determining control of a Heating Ventilation and/or Air Conditioning (HVAC) system serving a conditioned space. The invention further optionally includes pattern recognition for locating one or more people within the conditioned space and utilizing a measurement of infrared energy radiated by the one or more people in determining control of the HVAC.

### CROSS REFERENCE TO RELATED APPLICATIONS

Not Applicable

### THE NAMES OF THE PARTIES TO A JOINT RESEARCH AGREEMENT

Not Applicable

### INCORPORATION BY REFERENCE OF MATERIAL SUBMITTED ON A COMPACT DISC

Not Applicable

### BACKGROUND OF THE INVENTION

Heating, Ventilation, and/or Air Conditioning Systems (HVAC Systems) typically include a controller that includes a temperature sensing device, the temperature sensing device typically for installation within or near a space being conditioned by the overall HVAC system, or in the air flow space supplying return air back to the conditioning equipment from the space being conditioned. The output or measurements from the temperature sensing device is utilized in determining control of the HVAC system so as to provide a level of comfort in the conditioned space for people that inhabit, or that may eventually inhabit the conditioned space.

It is common in the HVAC industry to turn on or off or to set levels of conditioning of cooling, humidity, and air flow, for example, in order to provide an increased level of comfort to people while balancing costs, potential costs, or use of energy utilized in doing that conditioning.

Temperature in the space being conditioned is typically measured by a thermistor which provides a measurement of air temperature in the conditioned space.

The level of comfort of one or more people occupying a conditioned space may be different depending on the person. For example, what the person is wearing, what level of activity or what work a person is performing, what is the airflow, and other similar or related factors may all affect how “comfortable” a person is, and this may vary from person to person even in the same conditioned space.

### BRIEF SUMMARY OF THE INVENTION

Therefore it would be useful to provide a means and/or methodology for determining, assessing, or estimating information relating to a level of comfort of a person or persons who occupies or who may occupy a conditioned space and to include such person comfort information in determining control and/or control parameters of a conditioning system or HVAC system serving the conditioned space.

It has been observed by the present inventor that personal comfort may be related to a person's body temperature, and further to a person's skin temperature or skin surface temperature. That is, if a person's body or skin temperature is at a comfortable level he or she may be comfortable with lessened regard to the actual air temperature in the conditioned space. For example, a person working hard may have an increased (higher) body temperature and/or skin temperature in comparison to a person in the same environment who is not working, and therefore a change in the heating or cooling or ventilation of the space may provide a better level of comfort or an opportunity for better cost or energy savings. For example, a lower temperature of air in the conditioned space may be “comfortable” to a person physically working hard compared to a person not working, and therefore for example a thermostat may establish a lower room temperature in a space where a person's body surface temperature or skin temperature of his or her arms or head or forehead, for example, is found to be at a comfortable level. A person with a warmer forehead or arm temperature than another, for example, may be comfortable at a lower temperature in the conditioned space (or room), than a person with a cooler forehead or arm temperature.

Sensing of body temperature or skin temperature of people in a conditioned space can be accomplished, for example, utilizing an infrared imaging device such as an infrared camera, and then analyzing one or more images taken from the camera to recognize people in the room and then determine or estimate the body temperature or skin temperature of one or more people in the conditioned space. A determination and estimate of comfort can include sophisticated algorithms for recognizing an area in the infrared image as being a person's face, or body, or arms or other such details, and estimates of temperature for specific areas within the infrared image based on pattern recognition can be used as factors in controlling the HVAC system.

It will be appreciated that the terms “body temperature” or “skin temperature” are not precise terms in that a person's “body temperature” varies depending on which part of the body is being measured. With regards to the present invention, these terms are meant to be interchangeable and to describe a measurement of temperature such as that, for example, can be determined from analysis of an infrared image from a thermal imaging device which responds at least to light waves in the infrared region of frequency.

It is also important to note that the infrared sensor or infrared imaging device as incorporated as a part of the present invention is not a simple thermistor or device for measuring temperature of the air or an object immediately adjacent to the device. It is a device or apparatus for measuring temperature at a location not adjacent to the device itself, that is, at a point or points away from the device. An example would be an infrared camera or infrared device with a focusing lens or collimating apparatus included.

It has been observed in experiments that a person's temperature measured on an exposed body part such as his arm or neck with an infrared sensing device provides an indication of comfort level. For example a person performing significant physical work has been observed to have a skin temperature higher than a person in the same space that is not performing any significant physical work. At the same time it has been observed that the person working hard is comfortable at a lower level of air temperature in comparison to the person not performing any significant physical work.

In an illustrated embodiment of the present invention, an HVAC management or control system, such as a thermostat mounted on a wall, includes an infrared imaging device that serves as a part of a person temperature sensing apparatus. The person temperature sensing apparatus determines an estimated temperature or estimated relative or comparative temperature of a person in a conditioned space served by the HVAC system, and then utilizes that temperature or relative temperature in determining control or control parameters of the HVAC system.

In a further illustrated embodiment of the present invention, the person temperature sensing apparatus includes pattern recognition and/or digital signal processing means to determine where in a digital infrared image specific parts of the person's body are located, such as the x/y coordinates within the digital image of a head or arms, and/or a plurality of people's bodies or heads or arms and utilizes the estimated temperature or relative temperature of those specific areas in the image in determining the control or control parameters of the HVAC system.

In another embodiment of the present invention, a thermostat, typically designed for installation on a wall within conditioned space served by an air conditioning system comprises an infrared image sensing device, a digital image capture system operatively coupled to the image sensing device so as to capture a digital image, digital signal processing apparatus and control for processing the digital image and recognizing points or areas within the digital image which may represent a person or persons, and then determining from digital information associated with the digital image a measurement relative to body temperature of a person or persons recognized in the digital image. It will be appreciated that the term air conditioning system is to be interpreted to mean also heating systems, heat pump systems, heating/cooling systems, humidifiers, fans or other HVAC equipment providing for increased comfort in a space occupied by people. The measurement or measurements relative to body temperature of the one or more persons then utilized by the thermostat apparatus in determining control or control parameters then used in setting or determining control outputs from the thermostat.

In another embodiment of the present invention, the same images captured by an infrared camera to determine skin temperature of one or more occupants is further utilized to recognize one or more specific individuals and to use the “knowledge” that certain identified people are in the conditioned space to alter the HVAC control. As a further enhancement to the present invention, HVAC control parameters and programming are selected based upon previously stored profiles that specify parameters of programming known or set by the recognized individual to describe his or her preferences.

In another embodiment of the present invention, the thermostat control may optionally utilize an average or other composite parameters and settings of temperature indicating measurements for a plurality of people in the room. The HVAC control system control parameters and programming are determined based upon a prediction or anticipation of need for space conditioning based upon historical observations of a recognized individual. For example, if Joe enters a room and is recognized as being someone who typically performs physical labor at a high level, then the set point temperature for the room is immediately lowered, potentially before he even begins to actually start working, and before any rise or change in skin temperature is observed.

In another embodiment of the present invention, the thermostat control may further utilize a selected one or more a plurality of body temperature indicative measurements, such selection, for example, being based upon a maximum estimate of discomfort based on the plurality of body temperature indicative measurements.

In another embodiment of the present invention, the HVAC control apparatus or mechanism may incorporate a measurement of a reference surface within the digital image, the reference surface at a known or predictable temperature, or controlled to serve as a relative reference in comparison to the body temperature indicative measurements.

In a further embodiment of the present invention, a plurality or series of digital images captured from an infrared imaging device camera are analyzed with pattern recognition techniques applied to a plurality of the images. A determination is then made as to which one or more images best provide an image for analysis that includes a person's face or other specific position on the body or bodies of people in the room. The best or most useful measurement of skin temperature is then utilized in affecting effecting control of the conditioning system.

In a further embodiment of the present invention pattern recognition is applied in real time to a “live” image from the infrared imaging device so as to avoid storage or capture of the image for processing at a later time.

In a further embodiment, images of a plurality of people are utilized so as to control the conditioning system in a way to better establish a better level of overall comfort for a person in the conditioned space. For example, if three people are recognized to be in the conditioned space and the faces of all three people are identified by pattern recognition to be men or women, or a children, then this information is utilized to affect control of the HVAC conditioning system. The size of the people is of further consideration in affecting control of the HVAC conditioning system. For example, children might be more comfortable at a higher room temperature than a room full of adults.

In another embodiment of the present invention an infrared sensing device is utilized as part of a thermostat apparatus so as to detect temperature, or to make a measurement related to temperature, of an object, or specific object in a conditioned space. This measurement is then utilized to affect control of an HVAC conditioning system. In a further enhancement, the thermostat apparatus may optionally incorporate or include a locating or keying mechanism, such as a laser pointer, for identifying during a setup time the approximate physical location of measurement for the infrared sensing device.

In another embodiment of the present invention an infrared sensing device is utilized as part of a thermostat apparatus so as to detect temperature, or to make a measurement related to temperature, of a floor temperature in a conditioned space. That is, a measurement of floor temperature at some chosen location within the conditioned space. This measurement is then utilized to affect control of an HVAC conditioning system. In a further enhancement, the thermostat apparatus may optionally incorporate or include a locating or keying mechanism, such as a laser pointer, for identifying or guiding a user during a setup time to point the infrared sensing device so as to make a measurement of floor temperature.

In another embodiment of the present invention an infrared sensing device is utilized as part of a thermostat apparatus so as to detect temperature, or to make a measurement related to temperature, of an object, or specific object in a conditioned space. This measurement is then utilized to affect control of an HVAC conditioning system. In a further enhancement, the thermostat apparatus may optionally incorporate or include a locating or keying mechanism, such as a laser pointer, for identifying during a setup time the approximate physical location of measurement for the infrared sensing device.

In another embodiment of the previously presented forms of the present invention, a sensor pointing adjustment mechanism is included as part of the thermostat apparatus of the invention so as to allow for pointing the infrared sensing device, or the infrared imaging device in a suitable direction for observation of the conditioned space, or at an allocation suitable for making the floor temperature measurement, or for observing with the infrared imaging device a view suitable for use in making temperature measurements in the conditioned space.

In another embodiment of the present invention, an infrared imaging device is utilized as part of a thermostat apparatus so as to detect temperature or to make a measurement related to temperature of a plurality of locations or points in a conditioned space. This plurality of measurements is then utilized to affect control of an HVAC conditioning system.

### BRIEF DESCRIPTION OF THE SEVERAL VIEWS OF THE DRAWING

The invention will be better understood by means of the following description, given only as an example and in reference to the attached drawings. Other advantages, purposes and characteristics of the present invention will emerge from the following detailed description and with reference to the attached drawings, in which:

FIG. 1 illustrates one person in a room or conditioned space, with a digital image of the room captured from an infrared imaging device, pattern recognition apparatus and control recognizing the face of at that one person and making a determination relative to skin temperature of that person's face, and then utilizing that determination relative to skin temperature to determine whether more or less cooling or heating is needed to move the skin temperature of the single person closer to a comfortable level;

FIG. 2 illustrates measurements of facial skin temperature of a plurality of people in the room, the average of those facial skin temperatures utilized in determining control of a heating or cooling system; and,

FIG. 3 illustrates an infrared sensing device which can be adjusted with an adjustment mechanism so as to provide aiming directed to an object in the conditioned space.

### DETAILED DESCRIPTION OF THE SEVERAL VIEWS OF THE DRAWING

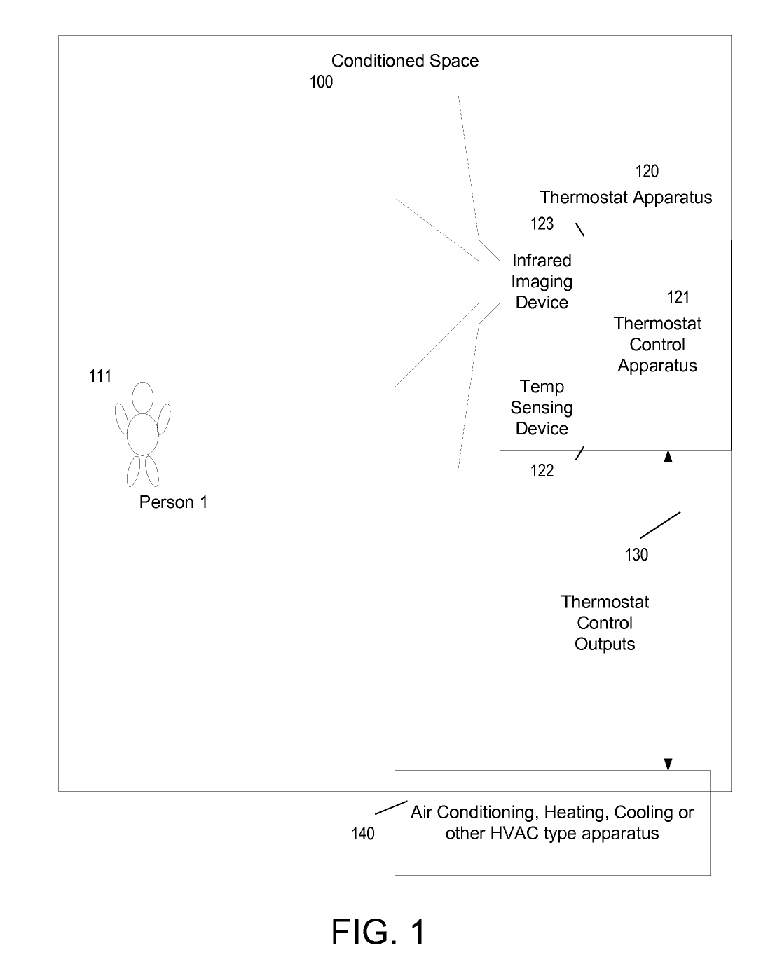

FIG. 1 depicts exemplary features of an illustrated embodiment of the invention illustrating a thermostat apparatus 120 comprising an infrared imaging device 123 and an air temperature sensing device 122 and provides thermostat control outputs 130 for controlling an HVAC system 140. The thermostat apparatus 120 is designed for installation in a conditioned space 100. The infrared imaging device is installed in a manner so as to provide observation of the room or conditioned space 120, and to provide an infrared image to the thermostat control apparatus 120. The thermostat control apparatus 120 utilizes pattern recognition techniques to locate/find a person 111 in the room or conditioned space 100. The thermostat control apparatus 121 determines by sensing the temperature of an observed portion of the person's body such as for example, an exposed forehead or arm. This area of the image is then analyzed to determine an approximate temperature of the person at or near that location. From this measurement related to temperature of the person, a determination is made by the control apparatus 121 utilizing pattern recognition analysis as to whether the person is likely to be comfortable, and this information is utilized in determining control of the air conditioning, heating, cooling or HVAC apparatus 140 through control outputs 130.

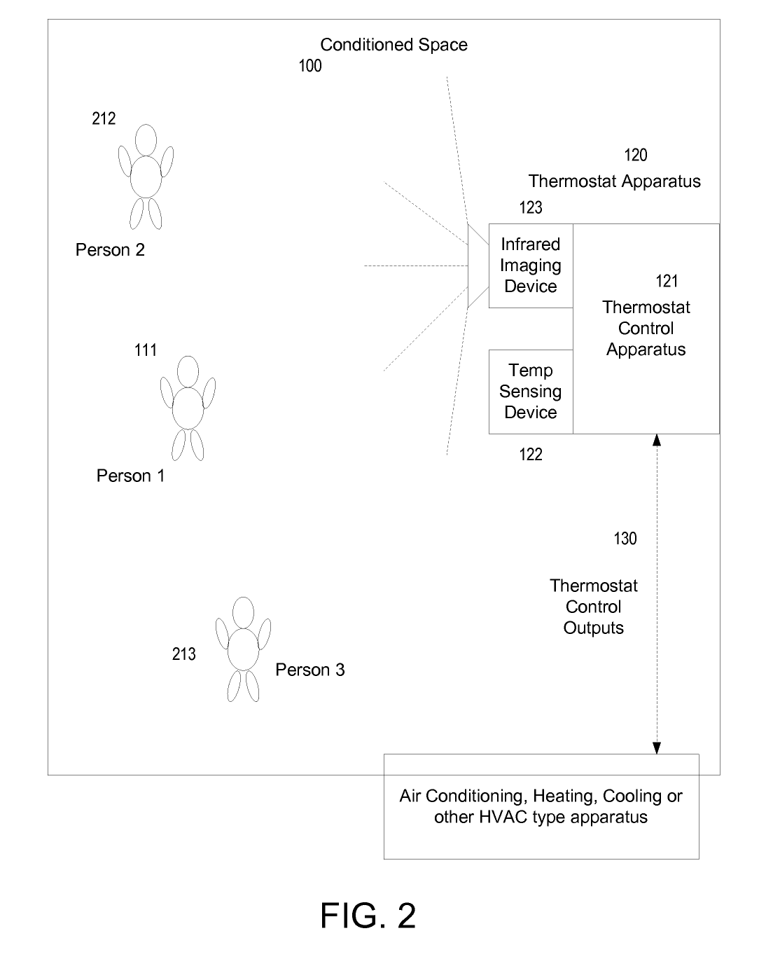

FIG. 2 depicts in an exemplary installation as FIG. 1 but with more people (person) 111, 212 and 213 illustrated to be in the room. The pattern recognition analysis “notices or detects” this plurality of people, and instead of utilizing just one person's “temperature”, it utilizes the measurements from more than area of the image corresponding to the location of the three exemplary people. This provides more data for possibly improving overall comfort. For example, utilizing an average temperature of the three people, or utilizing the lowest or highest measurement of several people might provide for determining better controls to provide best comfort, or better economy.

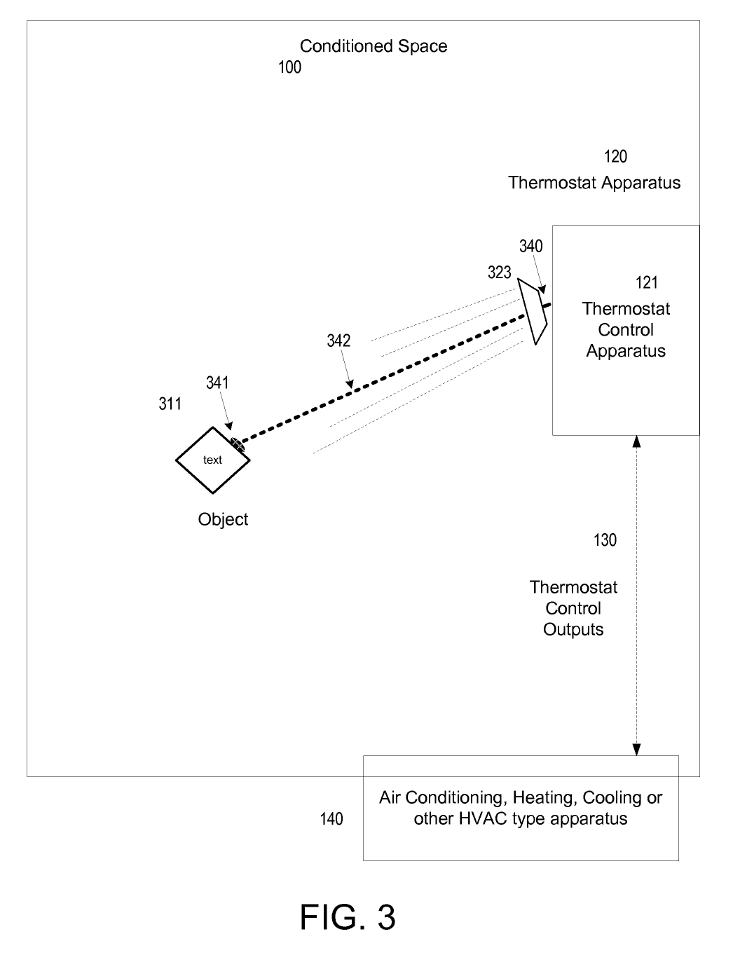

FIG. 3 depicts certain exemplary features of another exemplary embodiment of the present invention, the illustration including an infrared sensing device 323 which can be adjusted with an adjustment mechanism 340 so as to provide aiming directed to an object 311 in the conditioned space. The aiming is optionally assisted by providing an aiming spot or target 341 which may be for example a laser spot, or a cross-hairs within an image of the room or other aiming mechanisms which could be devised by one skilled in the art. The aiming is depicted with a laser beam 342 as an example. The aiming provides for the thermostat to make an estimation of temperature of an object in the room, such as temperature of a spot on the floor of a room or conditioned space. Other objects such as an outside wall in the conditioned space, or an outside window in the conditioned space or other objects identified as providing for enhancement to control of the HVAC system. In further optional enhancement a plurality of objects are identified for use in improving control of the HVAC system by providing more information to the overall thermostat control mechanism. It is noted that the aiming of the thermal imaging or thermal sensing device may or may not have to involve adjustment of the actual sensing mechanism or its lens or collimating device. The aiming may optionally include such mechanical adjustment but may also involve identification of useful spots on a thermal image.

Thus, while the principles of the invention have been made clear and described relative to a number of embodiments or implementations, it will be immediately obvious to those skilled in the art the many modifications or adaptations which can be made without departing from those principles. While the invention has been shown and described with reference to specific illustrated embodiments, it should be understood by those skilled in the art that various changes in form and detail may be made in such implementations without departing from the spirit and scope of the invention as defined by the following claims.

Having described the embodiments of the present invention, it will now become apparent to one of skill in the arts that other embodiments or implementations incorporating the teachings of the present invention may be used. Accordingly, these embodiments should not be construed as being limited to the disclosed embodiments or implementations but rather should be limited only by the spirit and scope of the following claims.

What is claimed is:

1. A thermostat apparatus having thermostat control outputs whose states or values are used for controlling a heating, ventilation, cooling, and/or air-conditioning system designed for conditioning air provided to a conditioned space, the thermostat comprising:
A) an infrared sensing device for making measurements of radiated infrared energy at one or more locations in the conditioned space remote from the infrared sensing device itself;
B) thermostat control apparatus operatively coupled to the infrared sensing device and utilizing the measurements of radiated infrared energy in controlling the states or values of the thermostat control outputs.

2. The thermostat apparatus of claim 1 further including an aim adjustment mechanism for assisting a user in pointing of the infrared sensing device to a suitable location for making the measurements of radiated infrared energy within the conditioned space.

3. The thermostat apparatus of claim 2 further including a guidance mechanism providing feedback information to a user as to where the infrared sensing device is pointing within the conditioned space.

4. A thermostat apparatus having thermostat control outputs whose states or values are used for controlling a heating, ventilation, cooling, and/or air-conditioning system designed for conditioning air provided to a conditioned space, the thermostat comprising:
A) an infrared imaging device providing as output an infrared measurement signal, the infrared imaging device observing at least a portion of the conditioned space remote from the infrared imaging device itself;
B) a processing and control apparatus operatively coupled to the infrared imaging device and determining from the infrared measurement signal one or measurements of person radiated infrared energy of people within the conditioned space; and,
C) thermostat control apparatus operatively coupled to the processing and control apparatus and utilizing the one or more measurements of person radiated infrared energy in determining the thermostat control outputs.

5. The apparatus of claim 4 further comprising a current air temperature sensing device providing a signal relating to current air temperature, and that signal relating to current air temperature is utilized by the thermostat control apparatus in determining the states or values of the thermostat control outputs.

6. The apparatus of claim 4 wherein the processing and control apparatus further determines a measurement relating to temperature of an object in the conditioned space, and that measurement relating to temperature of the object in the conditioned space is utilized by the thermostat control apparatus in determining the s states or values of the thermostat control outputs, and the thermostat control apparatus utilizes that measurement in determining the states or values of the thermostat control outputs.

7. The apparatus of claim 4 further comprising a room temperature sensing apparatus which makes a measurement relating to current air temperature in the conditioned space and the thermostat control apparatus utilizes that measurement related to current air temperature in the conditioned space in controlling the states s or values of the thermostat control outputs.

8. The apparatus of claim 4 wherein pattern recognition techniques are utilized by the processing and control apparatus in locating the one or more people in the conditioned space.

9. The apparatus of claim 4 wherein pattern recognition techniques are utilized by the processing and control apparatus in locating exposed skin of the one or more people in the conditioned space.

10. The apparatus of claim 8 wherein the thermostat control apparatus reverts to not utilizing the measurements of person radiated infrared energy in determining the states or values of the thermostat control outputs when the pattern recognition does not locate one or more people within the one or more captured infrared digital images.

11. A thermostat having thermostat control outputs whose states or values are used for controlling a heating, ventilation, cooling, and/or air-conditioning system designed for conditioning air provided to a conditioned space, the thermostat comprising:
A) an air temperature sensing apparatus for measuring a current air temperature value in the conditioned space;
B) an infrared imaging device for forming an infrared image of at least a portion of the conditioned space;
C) a processing and control apparatus for performing an image analysis of one or more infrared images from the infrared imaging device, the image analysis including pattern recognition for locating one or more people in the infrared images;
E) thermostat control apparatus operatively coupled to the digital signal processing and control apparatus and operatively coupled to the air temperature sensing apparatus and utilizing both the current air temperature value and results of the image analysis in determining the states or values of the thermostat control outputs.

12. The apparatus of claim 11 wherein the thermostat control apparatus utilizes further image analysis of the more than one of the captured infrared digital images to estimate a level of physical activity of the one or more persons in the room and utilizes that further image analysis in determining the states or values of the thermostat control outputs.

13. A thermostat apparatus having thermostat control outputs whose states or values are used for controlling a heating, ventilation, cooling, and/or air-conditioning system designed for conditioning air provided to a conditioned space, the thermostat comprising:
A) an infrared imaging device providing as output an infrared measurement signal, the infrared imaging device observing at least a portion of the conditioned space remote from the infrared imaging device itself;
B) a processing and control apparatus operatively coupled to the infrared imaging device and determining from the infrared measurement signal one or measurements of body temperature or skin temperature of people within the n conditioned space; and,
C) thermostat control apparatus operatively coupled to the processing and control apparatus and utilizing the one or more measurements of body temperature or skin temperature in determining the thermostat control outputs.

14. A thermostat apparatus having thermostat control outputs whose states or values are used for controlling a heating, ventilation, cooling, and/or air-conditioning system designed for conditioning air provided to a conditioned space, the thermostat comprising:
A) an infrared sensing device providing as output an infrared measurement signal, the infrared imaging device observing at least a portion of the conditioned space remote from the infrared sensing device itself;
B) a processing and control apparatus operatively coupled to the infrared sensing device and determining from the infrared measurement signal one or measurements of person radiated infrared energy of people within the conditioned space; and,
C) thermostat control apparatus operatively coupled to the processing and control apparatus and utilizing the one or more measurements of person radiated infrared energy in determining the thermostat control outputs.

15. A thermostat apparatus having thermostat control outputs whose states or values are used for controlling a heating, ventilation, cooling, and/or air-conditioning system designed for conditioning air provided to a conditioned space, the thermostat comprising:
A) an infrared sensing device providing as output an infrared measurement signal, the infrared imaging device observing at least a portion of the conditioned space remote from the thermostat;
B) a processing and control apparatus operatively coupled to the infrared sensing device and determining from the infrared measurement signal one or measurements of body temperature or skin temperature of people within the conditioned space; and,
C) thermostat control apparatus operatively coupled to the processing and control apparatus and utilizing the one or more measurements of body temperature or skin temperature in determining the thermostat control outputs.

16. A method for control of an air conditioning or heating system serving a conditioned space comprising the steps of:
A) analyzing an image from an infrared imaging device mounted so as to provide visibility of at least a portion of an area in the conditioned space, the analyzing including pattern recognition for determining location coordinates of one or more people in the conditioned space, and determining no location coordinates when one or more people are not recognized in the condition space;
B) when one or more people are determined to be in the conditioned space determining a level of infrared radiation at or near the coordinates of the one or more people and controlling the air conditioning or heating system based on the level of infrared radiation at those coordinates; and,
C) when one or more people are not determined to be in the conditioned space making a room temperature measurement relating to current air temperature in the conditioned space and using that room temperature measurement in controlling the air conditioning or heating system.
